(19) United States
(12) Patent Application Publication
(10) Pub. No.: US 2006/0286856 A1
(43) Pub. Date: Dec. 21, 2006

(54) Connector component and connector assembly

(75) Inventor: Rikio Sakamoto, Tokyo (JP)

Correspondence Address: DICKSTEIN SHAPIRO LLP, 1177 Avenue of the Americas, New York, NY, 10036, US

(73) Assignee: NEC Corporation

(21) Appl. No.: 11/508,160

(22) Filed: Aug. 23, 2006

Related U.S. Application Data
(62) Division of application No. 10/911,486, filed on Aug. 5, 2004.

(30) Foreign Application Priority Data
Aug. 5, 2003 (JP) 287132/2003

(51) Int. Cl. H01R 3/00

(52) U.S. Cl. 439/490

(57) ABSTRACT

A connector component of the present invention includes a first connector part which includes a housing having a first end from which a cable is protruded and a second end which is connectable to a second connector part. At least a part of the first connector part emits light or shines while the first connector part is connected to the second connector part. A connector assembly of the present invention includes a first connector part which has a first end from which a cable is protruded and a second end. The connector assembly also has a second connector part which is connected to the second end of the first connector part. When the first and second connector parts are correctly connected, at least a part of first connector part emits the light.

### CROSS-REFERENCE TO RELATED APPLICATIONS

This is a divisional under 37 C.F.R. § 1.53(b) of prior application Ser. No. 10/911,486, filed Aug. 5, 2004, the entirety of which is incorporated herein by reference.

### BACKGROUND OF THE INVENTION

This invention relates to a connector component and a connector assembly used for transmitting a signal through a cable, and more particularly, to a connector component and a connector assembly having male and female connectors for an electronic communication equipment such as a personal computer, a server and the like.

There is provided the prior art connector assembly having a light emitting diode (LED) fixed to a modular jack in order to perform a visual confirmation whether or not the modular jack and the modular cable are correctly connected to each other. For example, in the conventional connector assembly described in Japanese Utility Model Laid-Open publication No. Hei 3-112889, an optical cable is built in a modular cable and light emitted from the LED fixed to the modular jack is transmitted through this optical cable from one end to the other end of the modular cable inserted into the modular jack. Additionally, if a plurality of modular jacks are used and, the LED emitting a different color of light is allotted for every modular jack, thereby a connected position of the modular cable can be easily confirmed.

Further, another conventional connector assembly described in Japanese Patent Laid-Open publication No. Hei 11-283690 has a modular jack which is formed by transparent plastic material and the LED which is attached to the rear surface of the modular jack. This enables the LED to be replaced with another LED.

In the other conventional connector assembly described in Japanese Patent Laid-Open publication No. 2000-150045, an LED is attached to a side wall of a modular jack to prevent noise from the LED from interfering with a signal to the modular jack.

However, the aforesaid conventional technology has some problems indicated as follows. The conventional connector assembly described above is constructed such that the LED is attached to either an upper part or a lower part of the modular jack and the connection can be confirmed by means of the light emitted from the modular jack. However, when the modular jack is arranged at a deep part of a chassis of the device, it produces a problem that it is difficult to recognize the light emitted from the LED at the modular jack to confirm the connection is complete.

If the decision whether the connection is complete or not is solely based on sound (click) generated when the modular cable is inserted into the modular jack without visual confirmation, the modular cable has to be released and inserted into the modular jack again to confirm the connection even though the insertion of the modular cable appears to be complete.

### SUMMARY OF THE INVENTION

This invention has been invented in view of the aforesaid problems and it is an object of the present invention to provide a connector component and a connector assembly in which light emitted from a light source can be easily confirmed and a connection between the modular cable and the modular jack can be visually confirmed.

According to one aspect of the present invention, a connector component includes: a housing which has a first end from which a cable is protruded and a second end which is connectable to an opening; and a lock part which is arranged on the housing and fixes the housing to the opening while the housing is connected to the opening; wherein at least a part of the connector component emits light while the housing is inserted in the opening.

According to another aspect of the present invention, a connector component includes: a first connector part which includes a housing having a first end from which a cable is protruded and a second end which is connectable to a second connector part; wherein at least a part of first connector part emits light while the first connector part is connected to the second connector part.

According to another aspect of the present invention, a connector assembly includes: a first connector part which has a first end from which a cable is protruded and a second end; and a second connector part which is connected to the second end, wherein the at least a part of first connector part emits light.

### BRIEF DESCRIPTION OF THE DRAWINGS

Other features and advantages of the invention will be made more apparent by the following detailed description and the accompanying drawings, wherein:

FIG. 1 is a sectional view showing a first embodiment of the present invention in which a modular cable and a modular jack are separated;

FIG. 2 is a sectional view showing the first embodiment of the present invention in which the modular cable and the modular jack are connected to each other;

FIG. 3 is a sectional view showing a second embodiment of the present invention in which a modular cable and a modular jack are connected to each other;

FIG. 4 is a perspective view showing a third embodiment of the present invention in which a D -Subminiature (DSUB) plug and a DSUB receptacle are separated;

FIG. 5 is a perspective view showing the third embodiment of the present invention in which the DSUB plug and the DSUB receptacle are connected to each other; and

FIG. 6 is a perspective vie w showing the fourth embodiment of the present invention in which a DSUB plug and the DSUB receptacle are connected to each other;

In the drawings, the same reference numerals represent the same structural elements.

### DETAILED DESCRIPTION OF THE PREFERRED EMBODIMENTS

The preferred embodiment of the present invention has an arrangement in which light for use in confirming the connection between a modular cable and a modular jack is emitted from the modular cable. Such an arrangement overcomes a problem that the light emitted from a light source at the modular jack is hardly seen when the modular jack is arranged at a deep location of a chassis of a device. As the light source, for example, a light emitting diode (LED) can be used.

A connector assembly of the preferred embodiment includes the modular jack provided with an opening and the modular cable provided with a connector component at its tip. The connector component is connectable to the modular jack by inserting the connector component into the opening of the modular jack. The inside part of the modular jack is provided with the light source for radiating light toward the opening. The connector component is provided with a lock part for preventing the housing from being pulled off the modular jack. The lock part is formed in such a way that light incidence from one end thereof is outputted from the other end. Upon insertion of the connector component into the modular jack, the light output from the light source enters one end of the lock part and is output from the other end of the lock part. It is preferable that the light source is attached at a position opposing against one end of the lock part when the housing is inserted into the modular jack. With such an arrangement, it is possible to confirm the connection of the modular cable in reference to the state of light emitted from the lock part.

More preferably, the lock part is formed by, for example, an optical pipe. With such an arrangement, when the modular cable is inserted into the modular jack, the light emitted from the light source enters one end of the lock part, passes through the lock part to cause the light to be emitted at the other end of the lock part. As a result, an operator can easily recognize the light originated from the light source.

Now, the present invention will be described in more detail below.

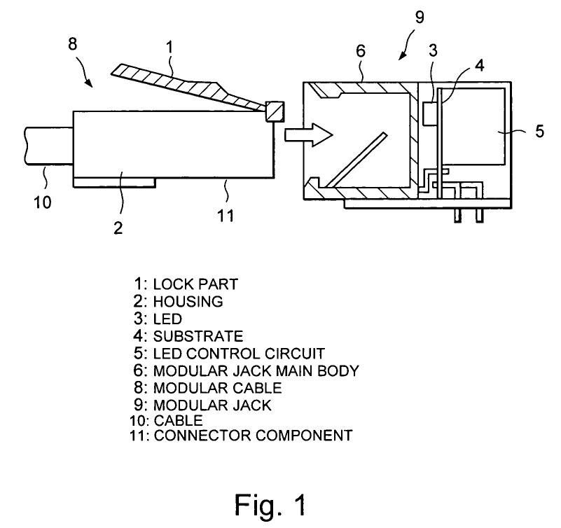

Referring to FIG. 1 showing a first embodiment of the present invention, a connector component 11 includes a lock part 1 and a housing 2. The connector component 11 and a cable 10 compose a modular cable 8. The connector component 11 is arranged at the end of the modular cable 8 and can be inserted into a modular jack 9. The modular cable 8 is formed by the connector component 11 and the cable 10 integrally or separately.

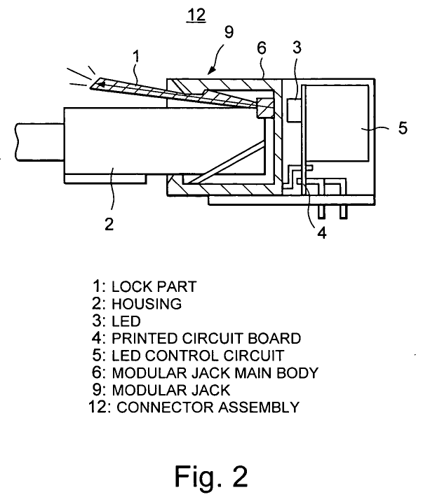

Referring now to FIG. 2, a connector assembly 12 of the preferred embodiment is formed by the modular cable 8 and a modular jack 9. The modular cable 8 and the modular jack 9 are connected while the housing 2 of the modular cable 8 is inserted in the modular jack9.

Additionally, referring to FIGS. 1 and 2, the connector component 11 is provided with the lock part 1 acting as a lock mechanism for preventing the housing 2 from being pulled off when it is inserted into the modular jack 9. In this embodiment, the lock part 1 is formed by an optical transparent type pipe which is a molded member formed by transparent resin and has a function for guiding light incidence at one end to the other end.

The modular jack 9 is provided with an opening part. An LED 3 acting as a light source is attached above the inner central part of the opening part. It is preferable that the LED 3 is fixed inside wall of the opening and faces one end of the lock part 1 at an opposing position when the connector component 11 is inserted in the modular jack 9. With this arrangement, light emitted from the LED 3 can efficiently enter the lock part 1. More preferably, the lock part 1 may be arranged at a position where the light emitted from the light source can efficiently enter, for example, a central position of the housing 2.

The LED 3 is mounted on a substrate 4. A circuit such as a pulse transformer or the like is assembled on the substrate 4 and an LED control circuit 5, which controls the LED 3, is connected to the substrate 4. A modular jack main body 6 is formed toward the opening from the LED 3. The housing 2 of the inserted modular cable 8 is held in the modular jack main body 6.

Next, the operation of the embodiment will be described.

Referring to FIGS. 1 and 2, the housing 2 of the modular cable 8 is inserted into the modular jack main body 6 of the modular jack 9. At this time, the light is emitted in advance by the LED 3 attached inside the modular jack 9. With this arrangement, when the modular cable 8 and the modular jack 9 are connected to each other, the light emitted from the LED 3 enters from one end of the lock part 1, which is inserted into the modular jack main body 6, passes through the lock part 1 and is output from the other end of the lock part 1. As a result, even if the modular jack 9 is arranged at a deep position of the device chassis, an operator can easily confirm the light emitted from the LED 3.

While the modular jack 9 has the LED 3 in the above embodiment, a plurality of LEDs emitting different colors, respectively, may be provided with the modular jack 9. In this case, the LEDs can emit light of multi-color by controlling the LED control circuit 5. Further, various kinds of message can be transmitted to the operator by changing either color or manner of illumination of the LEDs. For example, it is possible to represent various states such as a communication state between the electronic devices in addition to a connection state of the modular cable 8 and the modular jack 9 by changing either color of the LEDs. It is also possible to represent various states by a manner of emitting light in reference to one state in which an electrical signal is transmitted or received and the other state in which an electrical signal is not transmitted or received after the modular cable 8 and the modular jack 9 are electrically connected to each other.

In addition, it is also applicable that no light emission is produced in advance at the LED 3, but the LED 3 is set at the LED control circuit 5 in such a way that the light is emitted by the LED 3 when the modular cable 8 and the modular jack 9 are electrically connected to each other.

In the connector assembly 12, the LED 3 is attached at a position opposing against one end of the lock part 1. Due to this arrangement, when the connector component 11 is not completely inserted into the device or when its inserted position is displaced, an intensity of light emitted out of the other end of the lock part 1 varies. Thus, it is possible to confirm that the housing 2 is completely inserted into the modular jack 9, and the modular jack 9 and the modular cable 8 are correctly or stably connected to each other by recognizing the light emitted out of the other end of the lock part 1.

The connector component 11 and the connector assembly 12 are used for performing signal transmission through the cable. It is practical that the RJ-45 type modular jack and modular cable are used as the connector component and the connector assembly for signal transmission for personal computers or servers.

Next, the second embodiment of the present invention will be described in detail.

A connector component and a connector assembly of the second embodiment are provided with a housing which emits light or shines when it is connected to the modular jack. In the second embodiment, the same reference numerals are given to the same structural elements as in the first embodiment of the present invention.

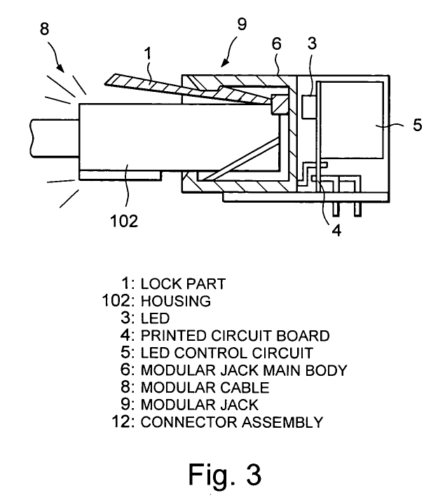

Referring to FIG. 3, the connecter assembly 12 has a housing 102 which emits light when the housing 102 is inserted and held in the modular jack 9. As the light source, a LED 3 is used. In this embodiment, no light emission is produced in advance by the LED 3, but the LED 3 is driven by the LED 3 control circuit 5 in such a way that light is emitted when the modular cable 8 and the modular jack 9 are electrically connected to each other.

When the LED is used for the light source, what is necessary is to make the surface of the housing 102 to reacts to or reflect the light of a light source. Thus, the housing 102 emits the light or shines. When the ultraviolet LED is used as the light source, a part or the whole of the housing 102 is made from luminescent resin or coated by fluorescence material or fluorescent paint. At least a part of the housing 102 reacts to the light from the ultraviolet LED and shines.

In the first and second embodiment s, either the lock part or the housing emits the light when the connector component is inserted in the modular jack. The present invention, however, is not limited to such a configuration. Both the lock part and the housing may emit the light simultaneously.

Next, the third embodiment of the present invention will be described in detail.

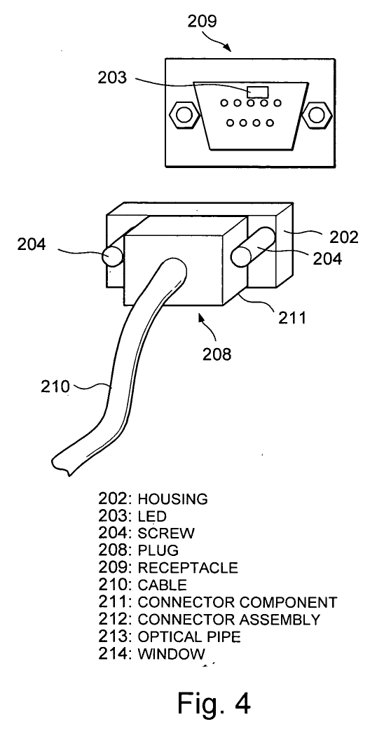

Referring to FIG. 4 , a connector component 211 is formed at the tip part of a plug 208. The connector component 211 can be connected to a receptacle 209 with screws 204. The plug 208 includes the connector component 211 and a cable 210. While any type of connector is applicable to the present invention, the plug 208 is a D-Subminiature (DSUB) plug and the receptacle 209 is a DSUB receptacle in this embodiment. A light source 203 such as LED for checking a connection state, is attached in the receptacle 209.

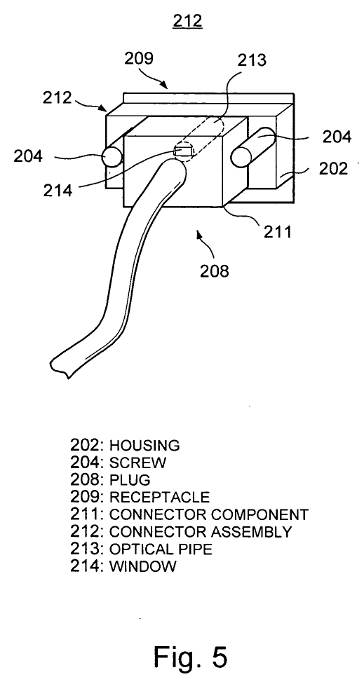

As shown in FIG. 5, a connector assembly 212 of the embodiment includes the receptacle 209 for connecting the connector component 211 and the plug 208. A light path is formed in a housing 202 which constitutes th e connector component 211. In this embodiment, the light path is formed by an optical transparent type pipe 213. The connection state of the connector can be checked because the light enters the optical pipe 213 from the LED 203, passes through the optical pipe 213 and emerges from a window 214.

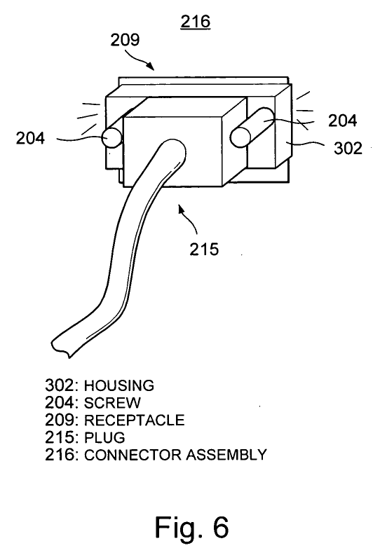

Referring to FIG. 6 which shows a fourth embodiment of the present invention, a connector assembly 216 includes a plug 215. The plug 215 has a housing 302. The housing 302 is formed or coated by the material which emits light or shines in response to the light of the LED 203 of the receptacle 209. A part or the whole housing 302 shines when the housing 302 is in the state where the receptacle 209 was connected with the plug 215.

In this embodiment, no light emission is performed in advance by the LED 203, but the LED 203 is driven by an LED control circuit in such a way that light is emitted when the plug 215 and the receptacle are electrically connected to each other.

As the same as the second embodiment, the surface of the housing 302 reacts to or reflects the light of a light source. When the ultraviolet LED is used as the light source, a part or the whole of the housing 302 is made from the luminescent resin or coated by fluorescence material or fluorescent paint. While this invention has been described in conjunction with the preferred embodiments described above, it will now be possible for those skilled in the art to put this invention into practice in various other manners.

What is claimed is:

1. A plug adapted to be coupled with a receptacle, said receptacle having an opening for receiving said plug and a light emitting element, said plug comprising:
a housing having a first end connected to a cable and a second end to be received in said opening of said receptacle; and
an optical pipe forming a light path guiding light from said light emitting element of said receptacle;
wherein said plug emits said light guided by said optical pipe when said plug is coupled with said receptacle.

2. The plug as claimed in claim 1, further comprising:
a lock part selectively fastening said housing to said receptacle; and
said optical pipe provided in at least one of said housing and said lock part.

3. The plug as claimed in claim 2, wherein said lock part is formed in an elongated shape having first and second ends, and said optical pipe forms a light path between said first and second ends of said lock part.

4. The plug as claimed in claim 3, wherein said optical element of said receptacle is provided in said opening thereof.

5. The plug as claimed in claim 3, wherein at least a part of said hosing is made from a light emitting resin.

6. A plug adapted to be coupled with a receptacle, said receptacle having an opening for receiving said plug and a light emitting element, said plug comprising:
a housing having a first end connected to a cable and a second end to be received in said opening of said receptacle;
a lock part selectively fastening said housing to said receptacle;
wherein at least one of said lock part and an optical pipe emits said light guided by said optical pipe when said plug is coupled with said receptacle.

7. The connector component as claimed in claim 6, wherein a part of said lock part emits the light while said housing is inserted in said opening.

8. The connector component as claimed in claim 6, wherein said opening has a light emitting element, and
said lock part emits the light by means of light emitted by said light emitting element.

9. The connector component according to claim 8, wherein the light from said light emitting element enters one end of said lock part, passes through said lock part, and exits from the other end of said lock part.

10. The connector component as claimed in claim 8, wherein one end of said lock part is connected to said housing and the other
end of said lock part is free end, and
wherein a light path is formed between one end of said lock part and the other end of said lock part.

11. The connector component as claimed in claim 10, wherein said lock part includes an optical pipe formed by transparent resin.

12. The plug as claimed in claim 6, wherein said optical pipe forms a light path between one end of said lock part and the other end of said lock part.

13. The plug as claimed in claim 6, wherein said optical pipe forms a light path between one end of said housing and the other end of said housing.

14. The plug as claimed in claim 6, wherein said optical element of said receptacle is provided in said opening thereof.

15. The plug as claimed in claim 6, wherein at least a part of said housing is made from a light emitting resin.

16. A plug adapted to be coupled with a receptacle, said receptacle having an opening for receiving said plug and a light emitting element, said plug comprising:
a housing having a first end connected to a cable, said housing adapted to be partially received in said opening of said receptacle;
a lock part removably connecting said housing to said receptacle; and
an optical pipe provided in at least one of said housing and said lock part, said optical pipe forming a light path guiding light from said light emitting element of said receptacle,
wherein at least one of said lock part and said optical pipe emits said light guided by said optical pipe when said plug is coupled with said receptacle.

17. The plug as claimed in claim 16, wherein said optical pipe forms a light path between one end of said lock part and the other end of said lock part.

18. The plug as claimed in claim 16, wherein said optical pipe forms a light path between one end of said housing and the other end of said housing.

19. The plug as claimed in claim 16, wherein said optical element of said receptacle is provided in said opening thereof.

20. The plug as claimed in claim 16, wherein at least a part of said housing is made from a light emitting resin.
